(19) United States
(12) Patent Application Publication
(10) Pub. No.: US 2010/0317558 A1
(43) Pub. Date: Dec. 16, 2010

(54) Use of a blend containing percarbonate for detergents and dishwashing formulations

(75) Inventors: Jurgen H. Rabe, Rheinbrohl (DE); Henk L. J. Venbrux, Tervueren (BE); Joerg Clemens, Wesel (DE)

Correspondence Address: Solvay;c/o B. Ortego - IAM-NAFTA, 3333 Richmond Avenue, Houston, TX, 77098-3099, US

(73) Assignee: SOLVAY (SOCIETE ANONYME), Brussels (BE)

(21) Appl. No.: 12/521,500

(22) PCT Filed: Dec. 21, 2007
(86) PCT No.: PCT/EP07/64517

§ 371 Date: Jun. 26, 2009

(30) Foreign Application Priority Data
Dec. 29, 2006 (EP) 06127378.5

(51) Int. Cl. C11D 3/10; C11D 3/395

(52) U.S. Cl. 510/218; 510/302

(57) ABSTRACT

Blend and use thereof for the manufacture of detergent or dishwashing formulations, the blends comprising a first type of particles containing sodium percarbonate having a mean particle size from 400 to 1000 μm and one or more further type(s) of particles, each type of particles having a different chemical composition.

The present application claims the benefit of the European patent application filed under the number 06127378.5 on Dec. 29, 2006.

### INTRODUCTION

The present invention generally is related to the use of a percarbonate containing blend for the manufacture of detergent and dishwashing formulations.

### BACKGROUND OF THE INVENTION

The use of sodium percarbonate (or sodium carbonate peroxyhydrate) as bleaching agent in detergent compositions for household fabric washing or dish washing is well known. Commonly such detergent compositions contain among other components zeolites as builder material, enzymes, bleach activators and/or perfumes. However, the interaction between sodium percarbonate and other formulation components leads to progressive decomposition of the percarbonate and hence to loss of bleaching power during storage and transportation of the composition.

A number of proposals have been made to overcome this problem, e.g. by interposing a layer between the sodium percarbonate and its environment, called a coating layer. However, while these coatings generally enhance the long term stability of the percarbonate, they often introduce further extraneous components into the detergent compositions, which should not only be avoided with respect to environmental considerations, but which in turn are likely to negatively affect the washing properties of the resulting formulations.

Furthermore, blends of sodium percarbonate and sodium carbonate, bicarbonate or sulphate are also known, however they are currently only used as bleach boosters. Bleach boosters are not to be used in the manufacture of detergent compositions themselves, but are conceived to be applied separately on the surface or fabric and left thereon for a certain time before the actual washing or cleaning step with a detergent.

Even so, bleach boosters for use alone, as well as percarbonate powders or particles for use in detergent compositions, before they are actually introduced in such formulations, are relatively hazardous goods and therefore must comply with strict national and international regulations with respect to packaging, handling, storage and transportation.

As the amount of percarbonate based raw materials for use in the manufacture of detergent, dishwashing and similar household and industrial compositions shipped worldwide represents approximately 500 000 MT per year with increasing tendency, one can easily imagine the surplus of costs resulting from the stringent safety regulations.

### OBJECT OF THE INVENTION

The aim of the present invention is therefore to provide for sodium percarbonate based raw material which is ready for formulation in the manufacture of detergent or dishwashing formulations, the blends presenting good long term stability, preferably being safer and reducing packaging, handling, storage and/or transportation constraints generally associated with known products, preferably also without containing further components extraneous to the target formulations, e.g. detergent or dishwashing compositions.

### GENERAL DESCRIPTION OF THE INVENTION

Consequently, the present invention concerns the use of a blend comprising a first type of particles containing sodium percarbonate having a mean particle size from 400 to 1000 μm and one or more further type(s) of particles, each type of particles having a different chemical composition, for the manufacture of detergent or dishwashing formulations.

The use of blends as defined above is a response to the ever-growing need of the detergent manufacturers for new and easily usable ingredients in the manufacture their products.

In a preferred embodiment of the invention, the total amount of constituents other than sodium percarbonate in the blend is such that the blend is classified as non-oxidiser according to the standard test method 0.1 of the UN Manual of Tests and Criteria, 4^{th} revised Edition, sub-section 34.4.1.

The United Nations, UN, have developed a scheme for the classification of certain types of dangerous goods and give descriptions of the tests and procedures to arrive at a classification for transport.

Dangerous goods are chemical substances or articles containing chemical substances, which can pose threat to public safety or to the environment during transport through chemical, physical, or nuclear properties if not properly identified or packaged. If they are accidentally released, undesirable outcomes such as fires and explosions can occur. The purpose of the various tests is to provide adequate protection against the risks to life and property inherent in the transportation of hazardous materials in commerce.

For example, percarbonate powders or particles, such as those currently used for the preparation of detergent formulations, are typically classified as oxidisers (Class 5—Oxidising Substances/Division 5.1) according to the test method O.1 of the UN Manual of Tests and Criteria, sub-section 34.4.1 (UN-O.1 test, Transport of dangerous goods, 4^{th} revised edition) and must be labelled and handled accordingly.

Hence, a major advantage of the invention is that the present blends are safer during packaging, handling, storage and transportation and do therefore not require particular technical precautions or equipment, which in turn considerably reduces the costs associated with their handling and shipping.

In a further preferred embodiment, the total amount of constituents other than sodium percarbonate in the blend is such that the blend has an available oxygen content of up to 13% by weight, preferably up to 12% by weight and most preferably up to 9% by weight.

The content of available oxygen (AvOx) is measured by titration with potassium permanganate after dissolution in sulphuric acid (see ISO standard 1917-1982). The maximum AvOx of the blends of percarbonate and additives to stay below the classification as 5.1 material is depending to a certain extent on the nature of the additive(s).

For instance, the sodium percarbonate blend of example 1 of this invention, wherein the additive is sodium carbonate, preferably has a content of available oxygen (AvOx) of up to 9% by weight. Consequently, the content of available oxygen may be adjusted to any value below this limit, such as from 3.0 to 9.0% by weight, preferably from 6.0 to 8.5% by weight, as required or desired for the intended use by controlling the amount of the non percarbonate additive(s).

Hence, an additional important advantage is that the upper available oxygen content indicated above is not only sufficient for most needs in the art of detergent and bleaching formulation, but this available oxygen content is easily adjustable within these limits so as to provide blends which are ready for use by the detergent manufacturer in the formulation of its detergents, without the need for any further treatment, equipment or handling.

In a further aspect, the invention provides for blends comprising of a first type of particles containing sodium percarbonate having particle sizes from 400 to 1000 μm and one or more further type(s) of particles, each type of particles having a different chemical composition, for the manufacture of detergent or dishwashing formulations, wherein the total amount of constituents other than sodium percarbonate in the blend is such that the blend is classified as non-oxidiser according to the standard test method O.1 of the UN Manual of Tests and Criteria, 4^{th} revised Edition, sub-section 34.4.1. The total amount of constituents other than sodium percarbonate in the blend is such that the blend has an available oxygen content of up to 13% by weight, preferably up to 12% by weight and most preferably up to 9% by weight.

As described above, the benefit of such blends is their increased safety and hence the reduced packaging, handling, storage and/or transportation costs generally associated with known products.

However, during handling and transportation of blends, a more or less important segregation of the different particles may arise, especially in adverse conditions, which may result in inhomogeneous blends. Inhomogeneous blends should however be avoided for at least two reasons. First, the detergent manufacturer is only likely to use the blends if he can be sure that introducing the same amount of blend results in introducing the same amount of each constituent, particularly of the active component, i.e. sodium percarbonate. Second, if segregation occurs, it is likely that some samples depending on their location inside the bulk will not fulfil the non-oxidiser requirements anymore after shipping.

Hence, the preferred blends above preferably show a particular resistance to segregation, even in heavily adverse conditions, making them particularly suited for long distance transports, etc, by applying measures known to the skilled person, such as by adapting density and/or size of the different particle types.

Even so, it is clear from the above, that the maximal AvOx of the blends has to be chosen in such a way that a certain segregation does not lead to a situation where some samples will not fulfil the non-oxidiser requirements.

The sodium percarbonate particles of the present invention have a mean particle size of at least 300 μm, in particular at least 400 μm, and more particularly at least 500 μm. The mean particle size is at most 1600 μm, especially at most 1400 μm, values of at most 1000 μm being preferred, for instance at most 800 μm.

The mean particle size of particles is measured using a sieve set (containing at least 6 sieves of known sieve aperture) to obtain several fractions and weighing each fraction. The mean particle size in μm (MPS) is then calculated according to the formula

$$MPS = 0.005 {\sum }_{i = 0}^{n} [ {m}_{i} ( {k}_{i} + {k}_{i + 1} ) ]$$

in which n is the number of sieves (not including the sieve pan), mᵢ is the weight fraction in % on sieve i and kᵢ is the sieve aperture in μm of sieve i. The index i increases with increasing sieve aperture. The sieve pan is indicated with the index 0 and has an aperture of k₀=0 μm and m₀ is the weight retained in the sieve pan after the sieving process. kₙ₊₁ equals to 1800 μm and is the maximum size considered for the MPS calculation. A typical sieve set which gives reliable results is defined as follows: n=6; k₆=1400 μm; k₅=1000 μm; k₄=850 μm; k₃=600 μm; k₂=425 μm; k₁=150 μm.

As mentioned above, the stability of the blends is an important aspect in the context of the invention. Hence, the present invention further concerns a blend containing sodium percarbonate particles and its use in detergent compositions, with a stability expressed as heat output at 40° C. measured (as described above) after storage during 7 days at 40° C., which is less than 30 μW/g. In particular, the heat output is less than 20 μW/g, preferably less than 15 μW/g, and most preferably less than 10 μW/g.

The sodium percarbonate containing particles of the present invention usually have a 90% dissolution time of at least 0.1 min, in particular at least 0.5 min. Generally, the 90% dissolution time is at most 3 min, especially at most 2.5 min. The 90% dissolution time is the time taken for conductivity to achieve 90% of its final value after addition of the sodium percarbonate containing particles to water at 20° C. and 2 g/l concentration. The method used is adapted from ISO 3123-1976 for industrial perborates, the only differences being the stirrer height that is 10 mm from the beaker bottom and a 2-litre beaker (internal diameter 120 mm).

In a further preferred embodiment, the first type of particles containing sodium percarbonate are coated and/or co-granulated with at least one additive.

The further types of particles and the additives usable in the present invention may be of any appropriate nature with respect to the intended use, i.e. in detergent compositions. In particular, the further types of particles and, if applicable, the additives are chosen from ingredients of detergent and dishwashing formulations acting e.g. as builder, alkaline source, filler, flowability enhancer and/or glass corrosion protector, such as, but not limited to, alkali metal or alkaline-earth metal sulphates, bicarbonates, trona, carbonates, citrates, phosphates, borates, silicates and/or chlorides, as well as their hydrates and mixtures thereof, preferably carbonates, bicarbonates, trona, silicates, phosphates (when legally allowed), citrates or sulphates; anhydrous sodium carbonate and bicarbonate being especially preferred. Sodium carbonate, sodium bicarbonate, trona and their mixtures are preferred.

It has to be noted that the use of liquid additive(s) as second or further additive(s) for one or more of the further types of particles is also possible, e.g. when carbonate, phosphates, citrates or other salts are used as solid additive in the further type of particles, these particles may be mixed with such an amount of such liquid substances, that the liquid is adsorbed from the solid additive. Such a liquid could be a liquid acid form of the additives already mentioned or e.g. a liquid surfactant or any other suitable liquid ingredient.

In an advantageous embodiment of the invention, the additive is sodium carbonate or a mixture of sodium carbonate and sodium silicate in an amount of 20 to 60% by weight, preferably 30 to 50% by weight and most preferable from 35 to 45% by weight, of the first type of particles containing sodium percarbonate.

In the blends, the further type of particles is preferably sodium bicarbonate, the available oxygen content of the blend being below 11% by weight, the blend having a sodium percarbonate content of between 70 and 90% by weight and a moisture content measured with the Mettler method (see below) of lower than 1.5% by weight. Sodium percarbonate contents form 60 to 80% wt, preferably from 65 to 75% wt, for instance about 70% wt, are advantageous.

As an alternative, the further type of particles may also be anhydrous sodium carbonate, the available oxygen content of the blend being below 8% by weight, the blend having a sodium percarbonate content of between 40 and 60% by weight and a moisture content measured with the Mettler method of lower than 1.5% by weight. Sodium percarbonate contents from 50 to 70% wt, preferably from 55 to 65% wt, for instance about 60% wt give good results.

Mixtures of anhydrous and hydrated forms of the above salts, such as anhydrous sodium carbonate and sodium carbonate monohydrate may also be used to regulate the water content to the desired value.

The above-described sodium percarbonate containing particles and the blends comprising them, may be produced by any suitable process.

In its basic form, a process for the preparation of a blend with particles containing only sodium percarbonate generally comprises the following steps:
(a) a manufacturing step of the sodium percarbonate,
(b) if necessary, a granulation step of the sodium percarbonate of step (a) to obtain particles having appropriate size,
(d) optionally, a drying step, and
(e) a blending step with further types of particles.

A suitable process for the preparation of a blend with particles containing both sodium percarbonate and at least one additive comprises a manufacturing step of the sodium percarbonate, followed by one or more treatment steps wherein the sodium percarbonate is co-granulated with at least one additive and/or coated with at least one additive.

In a first variation, the process for the preparation of a blend with particles containing sodium percarbonate coated with at least one additive, comprises the following steps:
(a) a manufacturing step of the sodium percarbonate,
(b) if necessary, a granulation step of the sodium percarbonate of step (a) alone to obtain particles having appropriate size,
(c) one or more coating steps comprising the coating of the particles obtained in step (b) with at least one additive, and
(d) optionally, a drying step,
(e) a blending step with further types of particles,
   wherein the additive(s) in each coating step (c) may be the same or different.

In a second variation, the process for the preparation of a blend with particles containing sodium percarbonate co-granulated with at least one additive and optionally further coated comprises the following steps:
(a) a manufacturing step of the sodium percarbonate,
(b) a co-granulation step of the sodium percarbonate of step (a) with at least one additive,
(c) if desired, one or more coating steps comprising the coating of the particles obtained in step (b) with at least one additive,
(d) optionally, a drying step, and
(e) a blending step with further types of particles,
   wherein the additive(s) in step (b) and in each coating step (c) may be the same or different.

The first step (a) for the manufacture of sodium percarbonate can be carried out by any known process for the preparation of sodium percarbonate.

According to a first option, step (a) can be a liquid crystallization process, in which a solution of sodium carbonate is mixed with a solution of hydrogen peroxide and the formed sodium percarbonate is precipitated into sodium percarbonate core particles, for instance by lowering the temperature and/or by adding salting out agents. The sodium percarbonate is separated from the liquid by for example centrifugation or filtration. A granulation step (b) is generally not required. An example of such a liquid crystallization process is described in the international application WO 97/35806 of SOLVAY INTEROX.

According to a second option, step (a) and (b) may be combined in a fluid bed granulation process, in which a solution or suspension of sodium carbonate and a solution of hydrogen peroxide are sprayed onto a bed of sodium percarbonate seeds which is fluidized with the aid of a fluidizing gas, the carbonate and the hydrogen peroxide react on the surface of the seed particles, the seed particles thereby grow into sodium percarbonate particles. An example of such a fluid bed granulation process is described in GB 1300855 of SOLVAY. In the case of a co-granulation step (b) in the second variation of the process, the additives are sprayed concomitantly with the sodium percarbonate and hydrogen peroxide, either as a mixture (in solution or suspension) with one or both or in a separate solution or suspension.

According to a third option, step (a) can be a direct process by reaction of a hydrogen peroxide solution with solid sodium carbonate and/or bicarbonate. An example of such a direct process is described in the U.S. Pat. No. 6,054,066 of SOLVAY INTEROX GmbH.

The sodium percarbonate particles obtained according to the first option of step (a) (liquid crystallization process) contain commonly more than 1% by weight of water, the water content being generally up to 15% by weight. The particles obtained according to the second option (fluid bed granulation process) contain in general less than 1.5% by weight of water, in particular less than 1% by weight of water, a water content of at most 0.8% by weight being most preferred. The particles obtained according to the third option (direct process) contain typically between 0.1 and 25% by weight of water.

The water content of sodium percarbonate particles is measured, in the framework of the present invention, according to the following method: a sample is heated and the amount of liberated water is measured by the METTLER method using a Halogen dryer METTLER HR73 equipment in which a cooled sample of about 7.5 g is placed on an aluminium dish, the sample is continuously weighed and dried at 60° C. until the weight is constant (maximum weight loss of 1 mg in 90 s).

The coating step (c) can be carried out by any adequate coating process, which allows the optionally dried sodium percarbonate particles to be brought into contact with the coating additive(s). Any type of mixer or fluid bed reactor can be used for this purpose as coating equipment. A mixer is preferred, especially those containing a mixing drum with rotating tools such as those of the Lodige type.

In step (c), the coating additive(s) can be used in the form of a solution (preferably an aqueous solution) or in the form of a suspension or slurry, or else in powder form. The use of a coating additive in powder form is described in the international application WO 01/62663 of SOLVAY (Societe Anonyme). Solutions of the coating additive are preferred, especially aqueous solutions.

During step (c), it is recommended to have a minimum amount of moisture present in the system to allow the coating layer to be bound onto the surface of the sodium percarbonate particles and/or the powders to be ‘glued’ onto the surface of the sodium percarbonate particles or in the coating layer. This moisture can already be present inside the sodium percarbonate particles. It can also be added as the diluent of the aqueous solution or slurry of the coating agent, or else it can be added as such. In the case of coating in a mixer, the moisture content is usually at least 2% by weight of the weight of the dried sodium percarbonate core particles, in particular at least 3% by weight, preferably at least 5% by weight. The moisture content can go up to 30% by weight of the weight of the dried sodium percarbonate particles, especially up to 20% by weight, in most cases up to 15% by weight. In the case of coating in a fluid bed reactor, the moisture content can be lower.

Step (c) of the above process is generally carried out at a temperature of at least 20° C. The temperature is in many cases at most 80° C., and especially at most 65° C.

In a particular form of realisation of the above process, step (c) is carried out in a mixer or in a fluid bed reactor or consecutively in a mixer and in a fluid bed reactor using at least one solution or suspension of at least one additive.

The drying step (d) can be done in any appropriate reactor, such as in a fluid bed drier, in a rotating drum drier, in an oven or in a circulating air oven.

The drying step (d) of the process of the present invention can be a distinct step from step (c) or can be carried out simultaneously with step (c) in the same equipment. When the coating step (c) is carried out in a fluid bed reactor, then the drying step (d) is preferably carried out simultaneously with the coating step (c) in the same fluid bed reactor. Typical temperatures for this step are from 50 to 210° C., especially from 100 to 160° C.

In the above process, it can further be advantageous to add at least one additional coating step between steps (c) and (d), optionally preceded by a drying step. This is particularly useful when the additional coating step(s) is (are) carried out in a fluid bed reactor.

The above process may further comprise one or more (intermediate or final) sieving step(s) in order to obtain final particles containing sodium percarbonate and/or blends having a D₉₀≧500 μm, i.e. 90% by weight of the particles have a diameter of 500 μm or more.

In the blending step (e), the optionally coated and/or co-granulated sodium percarbonate containing particles are blended using conventional methods, such as a mechanical mixer or a fluid-bed mixer, different mixing systems are described in Perry's Chemical Engineers' Handbook, seventh Edition; Chapter 19.10 to 19.16., with one or more further type(s) of particles of different chemical composition, comprising ingredients chosen among those defined above.

### EXAMPLES

### Example 1

### Blend of Soda Ash and Sodium Percarbonate

Dense soda ash (granulated sodium carbonate) and sodium percarbonate (Oxyper S131 with an AvOx of 13.7%) are mixed for 5 min in a plough shear mixer (Type Lödige) in a ratio of about 60:40 with some variation around this value (samples 1/3 to 3/3).

The ratio between sodium percarbonate (PCS) and soda ash (SA) was varied in a way that the resulting blends have an AvOx according in Table A below.

TABLE A

| | Sample | | |
|---|---|---|---|
| | BLEND | BLEND | BLEND |
| | 60/40 (1/3) | 60/40 (2/3) | 60/40 (3/3) |
| Moisture | 0.95% | 1.10% | 0.82% |
| (M60) | | | |
| AvOx | 7.52% | 8.08% | 8.93% |
| W (PCS) | 55.7% | 59.9% | 66.1% |

Due to the particle size distribution as listed in Table B, all samples are milled below 500 μm for the UN 0.1 test. The AvOx contents before and after sample preparation have been retested and confirmed.

TABLE B

| | Sample | | |
|---|---|---|---|
| | BLEND | BLEND | BLEND |
| | 60/40 (1/3) | 60/40 (2/3) | 60/40 (3/3) |
| W (>500 μm) | 53.3% | 60.8% | 66.4% |
| W (<500 μm) | 46.7% | 39.2% | 33.6% |

To answer the main question ‘Does the mixture of sodium percarbonate with soda ash show any oxidising properties related to Dangerous Goods of Division 5.1?’, only the reference time for packaging group III (PGIII) and the fastest burning mixture (here:sample to cellulose in a ratio of 4 to 1) are determined. The average reference burning times and standard deviations are given in Table C.

TABLE C

| | ratio | | |
|---|---|---|---|
| Sample | (solid:cellulose) | Time (s) | Classification |
| Reference PGIII* | 3:7 | 80 ± 5 | 5.1, PGIII |
| BLEND 60/40 | 4:1 | 92 ± 4 | Not 5.1 (non |
| (3/3) | | | oxidiser) |
| BLEND 60/40 | 4:1 | 108 ± 10 | Not 5.1 (non |
| (2/3) | | | oxidiser) |
| BLEND 60/40 | 4:1 | 124 ± 12 | Not 5.1 (non |
| (1/3) | | | oxidiser) |

*reference oxidising solid: potassium bromate (not according to the invention)

Considering the determined reference and sample burning times and its related standard deviations as shown in Table C, an AvOx content of ≧9% by weight may lead to a borderline classification in the case of dense soda ash as additive. Hence, in practice, a maximum AvOx of 8.5% by weight in a blend of percarbonate with dense soda ash can generally be used.

### Example 2

### Blend of Sodium Bicarbonate and Sodium Percarbonate

Sodium bicarbonate and sodium percarbonate are added continuously into a fluidised bed in a ratio of 70% by weight of percarbonate and 30% by weight of sodium bicarbonate.

For this assessment, two Oxyper S131 batches are used in two trials. The available oxygen content (AvOx) for both is determined at 13.7% by weight. The purity of used BICAR (bicarbonate) powder is determined at 97.9% by weight by acidic titration. Table D lists the related particle size distribution of used BICAR (sodium bicarbonate) powder. The AvOx of the resulting blend was about 9.5% by weight.

TABLE D
particle sizes of BICAR powder

| Mesh [μm] | % by weight |
|---|---|
| >500 | 0.8 |
| >250 | 1.3 |
| >125 | 64.4 |
| <125 | 33.5 |

For classification reasons, only the reference times for packaging group III or II and relevant 4:1 mixtures (sample to cellulose) are determined.

The content of fines below 500 μm is above 10% by weight; hence the sample is completely milled below 500 μm without excessive stress. The tested 4:1 mixtures do show small flames for a short time after ignition, which stop burning quickly. The main combustion of the mixtures could be characterized as ‘rapid glowing’.

The average reference and combustion times are listed in Table E. The AvOx of the tested blend was ˜9.5% by weight.

TABLE E
combustion rates in comparison

| | Ratio | | |
|---|---|---|---|
| Sample | (solid:cellulose) | Time (s) | Classification |
| Reference PGIII* | 3:7 | 84 ± 3 | 5.1, PGIII |
| Reference PGII* | 2:3 | 38 ± 2 | 5.1, PG II |
| BLEND70/30 | 4:1 | 159 ± 23 | Not 5.1 (non oxidiser) |
| sample 1 | | | |
| BLEND70/30 | 4:1 | 175 ± 16 | Not 5.1 (non oxidiser) |
| sample 2 | | | |

*reference oxidising solid: potassium bromate (not according to the invention)

In consequence, the results indicate a maximum possible sodium percarbonate content of more than 70% by weight in a blend with sodium bicarbonate to be a non-oxidising formulation in terms of transport.

1. A method for the manufacture of detergent or dishwashing formulations, using a blend comprising a first type of particles containing sodium percarbonate having a mean particle size from 400 to 1000 μm and one or more further types of particles, each type of particles having a different chemical composition.

2. The method according to claim 1, wherein the total amount of constituents other than sodium percarbonate in the blend is such that the blend is classified as non-oxidiser according to the standard test method O.1 of the UN Manual of Tests and Criteria, 4^{th} revised Edition, sub-section 34.4.1.

3. The method according to claim 1, wherein the total amount of constituents other than sodium percarbonate in the blend is such that the blend has an available oxygen content of up to 13% by weight.

4. The method according to claim 1, wherein the blend has a stability expressed as heat output at 7 days, 40° C. of below 20 μW/g.

5. The method according to claim 1, wherein the blend has a D₉₀≧500 μm.

6. The method according to claim 1, wherein the first type of particles containing sodium percarbonate are coated and/or co-granulated with at least one additive.

7. The method according to claim 6, wherein the further type or types of particles and, if applicable, the at least one additive are chosen from ingredients of detergent and dishwashing formulations acting as builder, alkaline source, filler, flowability enhancer, glass corrosion protector, or mixtures thereof.

8. The method according to claim 6, wherein the additive is sodium carbonate, or a mixture of sodium carbonate and sodium silicate in an amount of 15% by weight of the first type of particles containing sodium percarbonate.

9. The method according to claim 1, wherein the further type of particles is sodium bicarbonate, the available oxygen content of the blend is below 11% by weight, the blend has a sodium percarbonate content of between 70 and 90% by weight, and the particles have a moisture content measured with the Mettler method of lower than 1.5% by weight.

10. The method according to claim 1, wherein the further type of particles is anhydrous sodium carbonate, the available oxygen content of the blend is below 10% by weight, the blend has a sodium percarbonate content of between 40 and 60% by weight, and a moisture content measured with the Karl-Fischer method of lower than 1% by weight.

11. The method according to claim 1, wherein the further types of particles comprise components chosen from ingredients of detergent and dishwashing formulations acting as builder, alkaline source, filler, flowability enhancer, glass corrosion protector, or mixtures thereof.

12. A blend comprising of a first type of particles containing sodium percarbonate having a mean particle size from 400 to 1000 μm and one or more further types of particles, each type of particles having a different chemical composition, for the manufacture of detergent or dishwashing formulations, wherein the total amount of constituents other than sodium percarbonate in the blend is such that the blend is classified as non-oxidiser according to the standard test method O.1 of the UN Manual of Tests and Criteria, 4^{th} revised Edition, sub-section 34.4.1, and the total amount of constituents other than sodium percarbonate in the blend is such that the blend has an available oxygen content of up to 13% by weight.

13. The blend according to claim 12, having a D₉₀≧500 μm.

14. The blend according to claim 12, wherein the first type of particles containing sodium percarbonate are coated and/or co-granulated with at least one additive.

15. The blend according to claim 14, wherein the further types of particles and, if applicable, the at least one additives are chosen from ingredients of detergent and dishwashing formulations acting as builder, alkaline source, filler, flowability enhancer, glass corrosion protector or mixtures thereof.

16. The blend according to claim 14, wherein the at least one additive is selected from the group consisting of trona, alkali metal or alkaline-earth metal sulfates, bicarbonates, carbonates, citrates, phosphates, borates, silicates, chlorides, their hydrates, and mixtures thereof.

17. The blend according to claim 12, wherein the further types of particles are selected from the group consisting of trona, alkali metal or alkaline-earth metal sulfates, bicarbonates, carbonates, citrates, phosphates, borates, silicates, chlorides, their hydrates, and mixtures thereof.

18. The blend according to claim 12, wherein the further type of particle is selected from the group consisting of trona, sodium carbonate, sodium bicarbonate, and mixtures thereof.

19. The method according to claim 1, wherein the further type of particles is selected from the group consisting of trona, alkali metal or alkaline-earth metal sulfates, bicarbonates, carbonates, citrates, phosphates, borates, silicates, chlorides, their hydrates, and mixtures thereof.

20. The blend according to claim 6, wherein the at least one additive is selected from the group consisting of trona, alkali metal or alkaline-earth metal sulfates, bicarbonates, carbonates, citrates, phosphates, borates, silicates, chlorides, their hydrates, and mixtures thereof.
